(19) United States
(12) Patent Application Publication
(10) Pub. No.: US 2023/0393664 A1
(43) Pub. Date: Dec. 7, 2023

(54) SIGNALLING DEVICE FOR GENERATING A LIGHT SIGNAL WHEN DRIVING A VEHICLE

(71) Applicants: Alexander RECH, Graz (AT); Ines WÖCKL, Graz (AT)

(72) Inventors: Alexander RECH, Graz (AT); Ines WÖCKL, Graz (AT)

(21) Appl. No.: 18/033,083

(22) PCT Filed: Oct. 21, 2021
(86) PCT No.: PCT/AT2021/060392

§ 371 Date: Apr. 21, 2023

(30) Foreign Application Priority Data
Oct. 22, 2020 (AT) A 239/2020

(51) Int. Cl. G06F 3/01

(52) U.S. Cl. CPC G06F 3/017

(57) ABSTRACT

The present invention relates to a signalling device (10) for generating a light signal when driving a vehicle, comprising a fastening section (20) allowing reversible attachment to an upper arm (U) of a driver (D) of the vehicle and a signalling element (30) with a plurality of signalling means (32) for generating the light signal, further comprising a control module (40) for controlling the signalling element (30) with at least one sensor element (50) for detecting gestures of the upper arm (U) of the driver (D), wherein the control module (40) further comprises a distinguishing element (60) for distinguishing the recognised gestures of the upper arm (U) of the driver (D) from driving movements of the driver (D) when driving the vehicle.

The present invention relates to a signalling device for generating a light signal when driving a vehicle, a signalling system comprising at least two such signalling devices, and a recognition method for detecting a gesture of an upper arm of a driver when using such a signalling device.

It is known that drivers of unprotected vehicles in road traffic can achieve improved safety through signalling. Such unprotected vehicles can for example be bicycles, inline skates, manually operated scooters or electric scooters. In particular, these are vehicles in which the driver sits or stands directly on the vehicle without a protective shell and moves with the vehicle. The simplest solution, for example in order to indicate a change of direction, is to indicate the planned change of direction with the arm. However, to do this, the driver must release the handlebars of the vehicle and extend their arm accordingly on the intended turning side. This leads to reduced safety and, in particular, reduced stability when driving.

It has also been suggested that signalling devices be attached to the driver which are able to output a light signal for signalling. Such light signals were in particular provided in order to signal an intention to turn and to signal abrupt braking. However, a disadvantage of these solutions is that they also output the respective light signal in undesired situations. For example, the desired light signal must be selected and activated manually, for example by pressing a button. Alternatively, it is also known for particular gestures or movements of the driver or the vehicle to trigger the light signal. However, the sensitivity is not sufficient here, so that the gesture is not recognised clearly enough as a signalling request and consequently the light signal is not emitted, which is undesirable. It is also possible that gestures are wrongly recognised which were not intended as gestures, but are interpreted as gestures on the basis of normal driving movements, i.e. movements of the driver during normal driving of the vehicle. In such a case, light signals would be generated which should not be emitted. The sensitivity to emit a light signal only if this is desired by the driver, but then with a high degree of reliability, is not achieved with the known solutions. This leads to reduced acceptance by drivers and also to reduced safety when using such signalling devices.

It is the object of the present invention to remedy, at least partially, the disadvantages described above. In particular, it is the object of the present invention to provide a method of gesture recognition for the generation of a light signal offering high sensitivity in a cost-effective and simple manner.

The above object is achieved by a signalling device with the features of claim 1, a signalling system with the features of claim 11, and a recognition method with the features of claim 12. Further features and details of the invention are disclosed in the dependent claims, the description and the drawings. Naturally, features and details described in connection with the signalling device according to the invention also apply in connection with the signalling system according to the invention as well as the recognition method according to the invention and vice versa, so that with regard to disclosure mutual reference is, or can, always be made to the individual aspects of the invention.

According to the invention, a signalling device is used to generate a light signal when driving a vehicle. For this purpose, the signalling device has a fastening section allowing reversible attachment to an upper arm of a driver of the vehicle. In addition, the signalling device is equipped with a signalling element with a variety of signalling means for generating the light signal. The signalling device further comprises a control module for controlling the signalling element with at least one sensor element for detecting gestures of the upper arm of the driver. The control module is also equipped with a distinguishing element for distinguishing the recognised gestures of the upper arm of the driver from driving movements of the driver when driving the vehicle.

A core idea of the invention is based on increasing the safety of a driver when driving a vehicle. According to the invention, a vehicle is to be understood as any vehicle on which the driver is present in an unprotected or minimally protected manner, in particular without protective enclosure. These can for example be bicycles, scooters, inline skates, electric scooters or the like. Naturally, this definition includes both single-track and multi-track vehicles. According to the invention, the signalling device is equipped with a fastening section. This allows the signalling device to be attached to the upper arm of the driver in a reversible manner. In particular, this attachment is achieved in a manner resulting in a defined alignment, for example in that the fastening section has a positioning aid relative to the upper arm. If, for example, the fastening section is designed as a snap fastening, as will be explained later, this snap fastening can substantially only be attached to the upper arm of the driver in a single manner with a correspondingly single orientation. However, in principle, other fastening mechanisms for the fastening section are conceivable within the context of the present invention.

If the signalling device is located on the upper arm of the driver in the attached position, then one or more movements of the upper arm of the driver or the entire driver can be detected using the at least one sensor element. As will be explained in more detail later, such sensor elements are in particular equipped with acceleration sensors and/or gyro sensors. These are able to resolve acceleration parameters and/or gyro parameters for corresponding movements into the individual axes and then assign these to a gesture, or not, for example by comparing them with corresponding limit values. In other words, it is now possible for the driver to move the upper arm in a defined manner when driving the vehicle, for example while maintaining their grip on the handlebars. For example, in order to indicate an intention to turn, it is possible for the driver to move their elbow outwards in the desired turning direction. This outward movement can be registered as a gesture by the corresponding sensor elements, so that the light signal, for example in the form of a flashing turn signal, is then generated and output via the signalling means. This light signal can be terminated either after a given time, automatically, or again in a gesture-based manner, by a corresponding switch-off gesture.

A core idea according to the invention is that, in addition to the gesture recognition in the control module, a distinguishing element can carry out an additional method step within the framework of a recognition method according to the invention. For this purpose, the signalling device in the control module is equipped with the distinguishing element which, as will be explained later, interprets the received movement parameters in contrast to normal driving movements of the driver on the basis of corresponding position parameters, distinguishing filters and/or weighting parameters, and in particular can provide a distinguishing criterion. The distinguishing element is thus able to recognise normal driving movements as such and ensure that they are not misinterpreted as gestures. In other words, a signalling device according to the invention is able to recognise a gesture as a deliberate gesture, with high sensitivity, and then output the light signal. In addition however, the distinguishing element makes it possible to distinguish an intentional gesture from an unintentional gesture which has for example been performed as a result of a corresponding driving situation and a compensating driving movement of the driver, defining such a gesture as unintentional and, accordingly, not outputting, or suppressing, a light signal.

The distinguishing element can for example be designed as a comparison element and, in a recognition method according to the invention, can perform the step of comparing the registered movement parameters with signalling limit values. In other words, the functionality of distinguishing is achieved by performing an evaluation and/or interpretation of the registered movement parameters. In the simplest case, this can involve the comparison of parameters. However, more complex relationships, the use of characteristic diagrams and/or artificial intelligence are naturally also conceivable. Thus, a gesture can be recognised by the sensor element on the basis of the movement parameters and, by evaluating the parameters underlying this recognition, such a gesture can be distinguished from driving movements caused by influences during normal movement when driving the vehicle. The distinguishing module can be software-based and/or integrated into the control module as a physical unit.

Furthermore, the distinguishing element can have a calibration means for adaptive calibration of the distinguishing function. For this purpose, the calibration means and/or a separate positioning sensor can register at least one positioning parameter, for example in order to recognise whether the signalling device is arranged on a right or a left upper arm. The adaptive calibration can adjust individual distinguishing criteria, for example weighting these differently or assigning different signalling limit values to the different axes. This can improve the functional reliability of the signalling device, especially in as many different positions on the driver as possible.

To summarise, compared to the known signalling devices, a signalling device according to the invention is able to make a distinction between unintentional gestures in the form of driving movements and intentional gestures. As a result, this leads to the correctness of the generated light signal being significantly increased compared to the known solutions, since a light signal is only generated if a correct and intentional gesture has also been recognised. In contrast to known solutions, unintentional gestures do not lead to the emission of the respective light signal.

Among a wide variety of signalling means, a distribution of light from a single light source or from a small number of light sources, for example by means of light guides, is conceivable. The signalling means can thus be designed for direct light emission and/or for indirect light emission.

In the context of the present invention, suitability for reversible attachment to the upper arm is also to be understood to include an attachment to other body parts of the driver, in particular to the forearm and/or in the shoulder area of the driver. In principle, an attachment to the legs is also conceivable; however, the advantages according to the invention are best achieved with attachment to the arm of the driver.

Such a light signal can for example be a turn indicator in the form of a flashing light. A light signal in the form of a braking signal is also conceivable, which may for example be realised as a red continuous signal.

It can bring advantages if, in a signalling device according to the invention, the fastening section is designed, at least in sections, as a resilient snap fastening. Such a fastening section can also be referred to as a snap band and is in particular band-formed along its longitudinal extension. A slightly bent or curved design can produce a pre-tensioning in the stretched position which releases the pre-tensioning force after loosening, so that the pre-tensioning force, as the fastening force, rolls in this snap tape and this can embrace an upper arm of the driver arranged in between. This elastic force of the snap band in the fastening section then serves, as a holding force, to hold the fastening section and thus the entire signalling device in the desired position on the upper arm. Such a snap fastening makes it possible to dispense with manual fixation, such as required when using Velcro fasteners or the like. In addition, such a fastening option can be used independently of a mating fastening section, so that attachment to any surface of the upper arm, including the naked upper arm of the driver, is possible. This significantly increases flexibility in the use of such a signalling device. Last but not least, this allows automatic adaptation to the corresponding circumference of the upper arm, so that even with different anatomical conditions of the upper arm, a secure attachment can be achieved in a simple manner. It should also be noted that such a flexible snap band design of the fastening section is preferably combined with a rigid section for the control module, which may for example be arranged at one end of such a snap band.

It brings advantages if, in a signalling device according to the invention, the control module is arranged at one end of the fastening section. The control module is thus designed separately from the fastening section and can for example be surrounded by a rigid housing. This is in particular combined with a snap band as a fastening section according to the preceding paragraph. In addition, an arrangement at one end of the signalling device and thus the design of this end of the signalling device means that only a one-sided connection to the fastening section is necessary. In particular, this leads to simplified cabling, which allows the power supply and the communication between the control module and the signalling means to be connected only on one side of the control module. Furthermore, it is also possible that the control module has an outer gripping section, in particular a housing gripping section, which in a fastening movement allows the signalling device to be moved around the upper arm in such a way that the desired defined position for the signalling device is assumed. Last but not least, in such an embodiment the fastening section will move at least partially over the control module in order to hold the control module in close contact with the upper arm of the driver. In particular, it brings advantages if, as will be explained later, a vibration element is additionally arranged in the control module which can output haptic feedback to the driver in the form of a vibration signal when in direct contact with the upper arm of the driver. In addition to an output as a vibration signal, an output as an acoustic signal is also conceivable. Further advantages can be achieved if, in a signalling device according to the invention, the signalling means are at least partially, in particular completely or substantially completely arranged on the fastening section. This is to be understood to the effect that the fastening section assumes a dual function, i.e. in addition to the fastening function it also provides the signalling function. Due to the fact that, if fastened all around the upper arm of the driver, the geometric extension of the fastening section essentially corresponds to the practical arrangement section for the signalling means, this means that the extension of the signalling device, its weight and costs can be reduced through this double functionality. These signalling means are preferably arranged in rows or in a matrix on the fastening section and can for example be designed as LEDs. However, additionally or alternatively, corresponding signalling means may of course also be arranged in the area of the control module. In order to further improve signalling in the form of the light signal, it may also be possible to arrange a corresponding intermediate layer on the fastening section which, as an independent reflective layer, increases safety for the driver. A reflective layer as an intermediate layer for additional reflection of the signalling means also further increases the signalling effect and thus the safety function of the light signal. In addition to a design in the form of LEDs, the use of indirect signalling means is also conceivable. For example, the use of light guides is possible, which in particular allow a dispersed distribution of light from one or more light sources. For example, light from one or a small number of light sources can be guided via such light guides to defined output positions, so that the number of light sources can be reduced.

It is also advantageous if, in a signalling device according to the invention, the control module has at least two switches which are preferably arranged on two opposite sides of the control module. These switches are preferably switches for switching the control module on and/or off. They are intended to be pressed when attaching the signalling device to the upper arm or before/after attaching the signalling device to the upper arm in order to activate the control module and the recognition method which will be explained later. Preferably, these switches are arranged on the top and the bottom in relation to the fastening position of the signalling device on the upper arm, so that they are essentially automatically pressed by the driver when gripping the signalling device to perform the fastening movement. This leads to a further increase in safety, since a defined and, above all, predictable relative positioning of the signalling device relative to the upper arm can be achieved during the fastening movement. These switches may protrude through a corresponding covering, in particular in the form of a waterproof covering, or may be arranged beneath this. In addition to switching it on and off, the switches can also be used to switch between different modes of operation of the signalling device.

Further advantages can be achieved if, in a signalling device according to the invention, the control module has an electrical storage element and a charging element for contactless charging of the electrical storage element. Such an electrical storage element may, for example, comprise a battery element, in particular a rechargeable battery element. However, capacitive storage elements, for example in the form of electrical capacitors, are conceivable in the context of the present invention. As already mentioned, it can be advantageous if the entire signalling device is surrounded by a cover, especially a waterproof cover. In such an embodiment, it brings advantages if a contactless charging element allows contactless charging through this closed and waterproof cover. In particular, this is an inductive charging element.

It is also advantageous if, in a signalling device according to the invention, the control module has a communication module for wireless communication. In particular, this involves low-energy communication, preferably short-range communication. For example, Bluetooth low energy communication can be used here. However, in more elaborate embodiments of a signalling device according to the invention, more complex and/or energy-intensive communications are conceivable, for example WLAN connections or mobile phone connections. However, the reduction to low-energy wireless communication leads to a reduction in the costs and weight of the signalling device, since a smaller electrical storage unit is sufficient and/or an extended operating time can be made possible. Wireless communication is used to communicate with a mobile device, for example, as a counter-communication means in order to allow calibration, setup or update of the software on the signalling device. In addition or alternatively, this wireless communication can also be used to exchange data with another signalling device which is for example arranged on the opposite upper arm of the driver. Last but not least, possibilities for wireless data exchange with other vehicles, the driver's own vehicle or other road users can also be made available in this way.

A further advantage can be achieved if, in a signalling device according to the invention, the control module includes at least one of the following sensor elements:
distance sensor,
acceleration sensor,
gyro sensor,
blind spot sensor,
light sensor
magnetic sensor,
attachment sensor.

The above list is a non-exhaustive list. The acceleration sensors and/or the gyro sensors are preferably at least uniaxial, in particular biaxial, preferably triaxial, wherein the individual axes are preferably perpendicular to each other and form a Cartesian coordinate system in the triaxial embodiment. With the help of a distance sensor and/or a blind spot sensor, it is possible to integrate an additional functionality. In addition to emitting a corresponding light signal for signalling, the driver can be provided with haptic feedback, for example via a vibration element, if an object is detected within the blind spot. This makes it possible to pass on a blind spot warning to the driver. The acceleration sensors and/or the gyro sensors can preferably be used for the direct or indirect recognition of the intended gesture and preferably also for distinguishing in the distinguishing element. A light sensor can for example be used to adjust the brightness of the light signal to the ambient situation. For example, in particularly bright outdoor light conditions, a particularly bright activation of the light signal will be necessary in order to achieve corresponding perceptibility within the environment. In dark outdoor conditions, it makes sense to emit a correspondingly lower light intensity in order to avoid dazzling other road users. A magnetic sensor allows the definition of an absolute coordinate system with respect to the Earth's magnetic field. In particular, this can improve accuracy in distinguishing between intentional and unintentional gestures. An attachment sensor, for example in the form of a proximity sensor, can detect whether or not the signalling device is attached to an upper arm. This information can be used to automatically activate and/or deactivate the signalling device. In particular, with the help of the sensors, different light signals can also be generated on the basis of different gestures and movements. For example, as a result of an arm movement, this gesture can lead to a flashing turn signal. Using appropriate acceleration parameters, a deceleration can be detected which can be interpreted as a gesture for a braking signal. It also brings advantages if, in a signalling device according to the invention, the control module has a vibration element for outputting a vibration signal and/or an acoustic element for outputting an acoustic signal to the driver. For example, such a vibration signal may indicate an object in the blind spot, as already explained in the preceding paragraph. However, other haptic feedback signals are conceivable, for example information about the signalling device being switched on and/or switched off. Haptic feedback can also confirm to the driver recognition of a gesture, so that the driver recognises that this gesture has been correctly recognised, even without optical recognition of the generated light signal. The end of generation of the light signal, i.e. termination of its output, can also be reported back to the driver in this way. Preferably, the vibration signal is specific for the respective information fed back to the driver and/or the corresponding type of generated light signal. Such a vibration module may also be arranged at an end of the signalling device opposite to the control module. This improves the arrangement in particular since, for example, when using a snap band for the fastening section, the vibration module automatically comes into direct contact with the upper arm of the driver. In addition or alternatively, the described feedback can also be output by means of an acoustic signal.

It can also be advantageous if, in a signalling device according to the invention, the signalling element has a cover, which in particular also surrounds the control module, and which is preferably transparent and/or partially transparent. This cover can, for example, be waterproof and thus preferably protect the entire signalling device against spray or even against immersion. The transparent or partially transparent design allows the signalling means to be positioned simply and cost-effectively since, for example if tube-like in design, the cover is then pulled over the signalling device and then closed. A transparent design means, in particular, a completely transparent design. However, colour filters can of course also be used which as part of this transparent design provide white LEDs with different colour variants. This allows flexibility for different colour variations despite the uniform use of white LEDs with a higher variability of different product variants for the signalling device.

In addition, an object of the present invention is a signalling system comprising at least two signalling devices according to the invention. Thus, a signalling system according to the invention has the same advantages as have been explained in detail with regard to a signalling device according to the invention. Preferably, the individual signalling devices are identical or substantially identical in design. The signalling devices are designed to be arranged on the two upper arms of the driver, i.e. on their left and right side. However, it is for example also possible to attach additional signalling devices to the thighs, the lower legs or also to a backpack worn by the driver. In a signalling system with at least two signalling devices, signalling devices are in particular used which are designed to communicate wirelessly with each other.

Another object of the present invention is a recognition method for recognising a gesture of an upper arm of a driver in a signalling device according to the present invention, comprising the following steps:
registering movement parameters of movements of the upper arm by means of the at least one sensor element,
comparing registered movement parameters with signalling limit values,
generating the light signal based on the result of the comparison.

A recognition method according to the invention thus brings the same advantages as have been explained in detail with reference to a signalling device according to the invention. In general, it is possible to register movement parameters using the sensor element and then to recognise gestures as intentional gestures on the basis of these movement parameters by comparing them with corresponding signalling limit values and to distinguish unintentional gestures from unintentional¹ signalling. The light signal is therefore only generated if the comparison outputs a result of an intentional gesture. The signalling limit values are preferably specific for the respective movement parameter, i.e. an acceleration movement parameter, a gyro parameter or a position movement parameter. Preferably, both the movement parameters and the associated signalling limit values are additionally specific for the respective axis orientation of the measuring sensor or the determined and registered movement parameter. The registered movement parameters also allow conclusions to be drawn as to the direction of movement and/or the direction of acceleration of the vehicle. ¹ Translator's note: The German says ‘unerwünschter’ ie ‘unintentional’, but it would be logical to assume they meant ‘gewünschter’ ie ‘intentional’.

When carrying out the recognition method on a signalling device according to the invention, the step of registration by the sensor element, the step of comparison by the distinguishing element and the step of generation by the signalling element are performed. All three steps are controlled by the control module of the signalling device.

The individual elements, in particular the distinguishing element, may be at least partially and/or completely integrated in the control module as a computer program product.

With a recognition method according to the invention it is possible to assign movement parameters with regard to their origin and thus assign their origin either to an active gesture of the upper arm of the driver or to a driving influence. In the case of driving influences, this means that unintentional gestures are for example generated from unevenness in the road surface, vibrations or balancing movements of the driver which can be defined as unintentional by comparing the movement parameters with the signalling limit values.

Furthermore, it is possible to change the signalling limit values directly. This can for example be done on the basis of training data by means of which new models are created, which in turn adapt the precision of the recognition method specifically to the respective driver. This can be done alternatively or in addition to the use of distinguishing filters, position parameters and/or weighting parameters, which will be explained later.

It should also be noted that the registering is preferably interrupt-based. For example, a measuring frequency or registering frequency above 100 Hz is conceivable. Naturally, two or more gestures can also be used for the same signalling. For example, a classic turning indication with an arm extended to the side can provide a first signalling of a turning signal, while another gesture, with the hand on the handlebars, also triggers the same signalling and thus the generation of a turning light signal. In addition, it is also conceivable that the movement parameters contain further information, such as a detection of a fall or an accident. In such a case, a hazard light signal in the form of a flashing hazard light can also be output. It is also conceivable that an emergency call is made via a wireless communication via a connected mobile phone.

It brings advantages if, in a recognition method according to the invention, the registered movement parameters are filtered by means of a distinguishing filter and then used in the filtered version as a basis for comparison. This means that, based on the existing knowledge about the normal driving movements, these are already filtered out before a comparison with the signalling limit value takes place. This distinguishing filter can for example be a fixed distinguishing filter which for example automatically filters out high vibration frequencies as driving influences. The distinguishing filter can also be variable and can for example be designed as a learning or self-learning distinguishing filter. It is also possible that particularly low frequencies, in particular the force of gravity, are filtered out using a distinguishing filter. It is irrelevant whether different filter functions are applied in a common distinguishing filter or in separate distinguishing filters. Overall, this allows a measurement and interpretation cycle in the range between 6 and 8 ms. The individual movement parameters can of course be subject to mathematical processing, so that in particular a curve sketching of the movement parameters takes place over time. It is thereby possible to take into account the slope, curvature and/or the inflection points of such movement parameters and their progression over time.

It is also advantageous if, in a recognition method according to the invention, at the beginning of the method at least one positioning parameter is registered which is specific in particular for at least one of the following positionings:
positioning on the left or right upper arm of the driver
positioning with respect to gravity
positioning in relation to the vehicle

The above list is a non-exhaustive list. The positioning on the respective upper arm makes it possible to adjust the different movement parameters to this positioning. The positioning information regarding the vehicle, in particular resulting from the sitting or standing position of the driver, can also provide information about the type of vehicle. This in turn then allows the signalling limit values and/or the distinguishing filter to be changed simply or in combination on the basis of one or more position parameters. Also, different gestures and thus different light signals can for example also be activated and/or blocked on the basis of a recognition of different vehicles.

For example, it is possible that in a recognition method according to the invention, at least one signalling limit value and/or a distinguishing filter and/or a weighting parameter for at least one axis of the movement parameter is changed based on the at least one positioning parameter registered. It thus becomes possible to use the positioning parameters as an influence on the signalling limit value, the distinguishing filter or a weighting parameter. This makes it possible to adapt the actual distinguishing function to a current environmental situation or positioning situation. This step can also be understood as adaptive calibration and is in particular carried out using trained artificial intelligence. All in all, this leads to a further improved distinction between intentional gestures and unintentional gestures. In this way it is also for example possible to reduce the influence of an axis, for example the gravitational axis, in order, for example when detecting braking, to provide an improved distinguishing capability and thus an increased sensitivity through reduced weighting during evaluation.

It may also be advantageous if, in a recognition method according to the invention, at least one signalling limit value and/or a distinguishing filter and/or a weighting parameter is adjusted by means of an input step. This is in particular to be understood as a manual adjustment carried out directly on the signalling device, or also by wireless communication connected to a mobile unit, for example a smartphone. Such manual configuration can for example involve switching off a signal or setting defined limit values. Of course, separate gestures are also conceivable as such manual input steps, for example switching off a signal in the event of incorrect activation. Such a detected false activation and corresponding information provided through the associated gesture can be stored, so that in the case of a self-learning system this input results in a further development of the distinguishing ability. An input from a separate vehicle or from the moving vehicle is also conceivable in principle.

It may also be advantageous if, in a recognition method according to the invention, a specific light signal is output via the signalling element on activating and/or deactivating the control module, in particular including information about an electrical charge state. While in principle this output is possible in order to indicate that the signalling device is now in the activated state or in the deactivated state, the information about the charge state can bring a further improvement. For example, flashing at low battery level can prompt the user and thus the driver to perform a charging process. Also, for example where a plurality of signalling elements is used, a bar-shaped display can communicate the percentage charge situation to the driver.

It also brings advantages if, in a recognition method according to the invention, the type and/or direction of the generated light signal is dependent on a detected and/or predetermined positioning of the signalling device. For example, a turning signal in the form of a flashing signal can only be output to the side and/or only to the rear. A brake light is preferably directed only to the rear and may emit a flashing light signal to the rear in the event of emergency braking. It is also conceivable that flashing in the area of the blind spot is avoided in order to reduce glare affecting the driver. It is further advantageous if, in a recognition method according to the invention, where used in a signalling system according to the present invention, the control modules of the signalling device communicate with each other and in particular coordinate the generated light signals and/or check the registered movement parameters for plausibility. For example, a temporal correlation of the flashing and/or a temporal harmonisation of the start of signalling when a constant brake light is emitted in braking mode is conceivable. It can also be ensured that only one side actually emits a light signal when indicating a turn. Last but not least, the duplicate sensors make it possible to check the plausibility of individual movement parameters. For example, a movement parameter which is detected by both signalling devices can be interpreted as an unintentional gesture, since an intentional turning gesture is usually only given by a single upper arm.

It is also advantageous if, in a recognition method according to the invention, a switch-off movement and/or a switch-on movement is detected on the basis of the movement parameters and the control module is then switched off and/or switched on. For example, when the signalling device is raised or removed from the arm, this can be interpreted as a corresponding movement. Rolling up the fastening section into a packing state can also be such a movement. The switched-off state is preferably a so-called super low power state, which can basically detect a switch-on movement or activation by means of buttons.

Further advantages, features and details of the invention are explained in the following description, in which exemplary embodiments of the invention are described in detail with reference to the drawings. The features mentioned in the claims and in the description may in each case be essential to the invention individually or in any combination. In each case schematically:

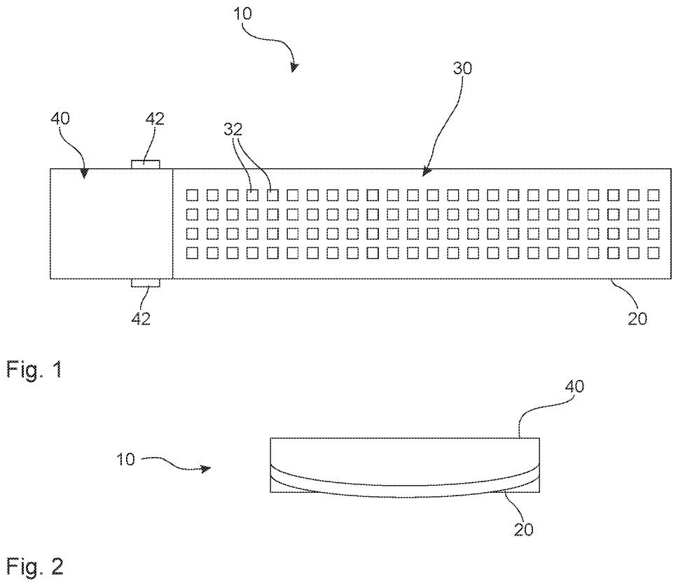

FIG. 1 shows an embodiment of a signalling device according to the invention,

FIG. 2 shows a side view of the embodiment of FIG. 1,

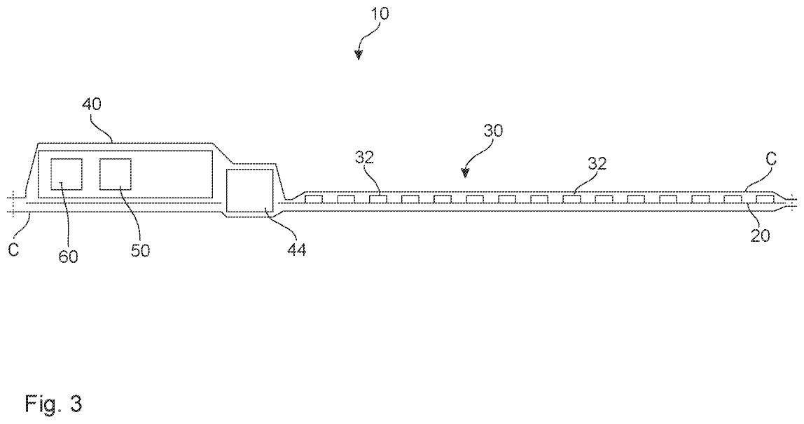

FIG. 3 shows a schematic cross section of a further embodiment of a signalling device according to the invention,

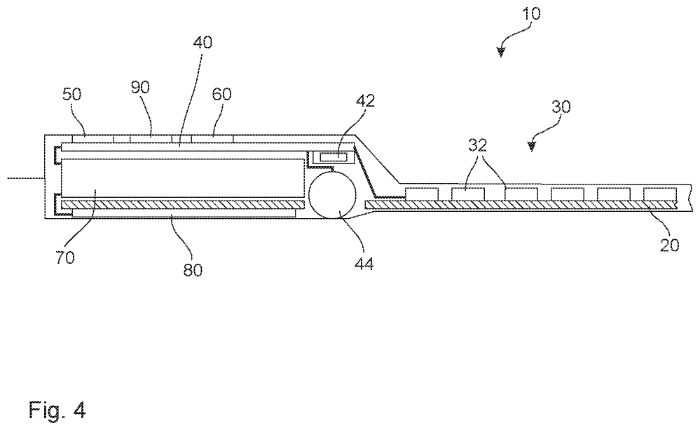

FIG. 4 shows a schematic cross section of a further embodiment of a signalling device according to the invention,

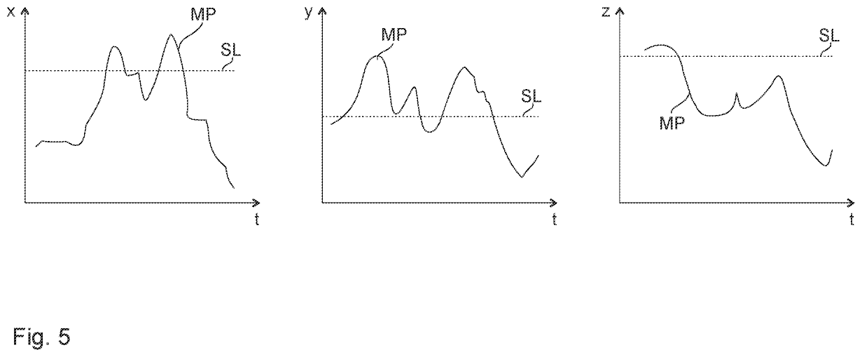

FIG. 5 shows a possible formation of movement parameters,

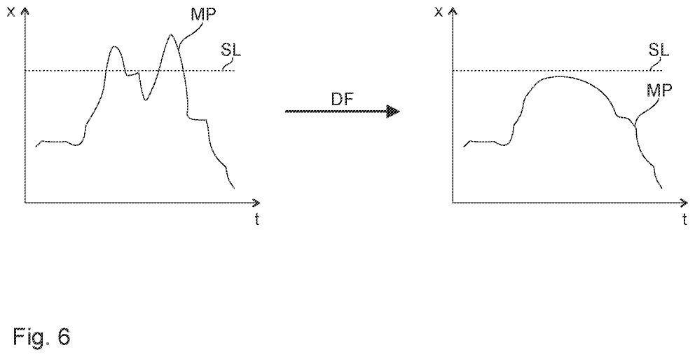

FIG. 6 shows a possible application of a distinguishing filter,

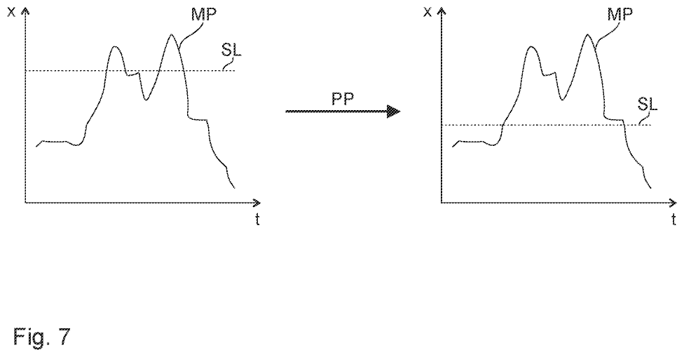

FIG. 7 shows a possible application of positioning parameters,

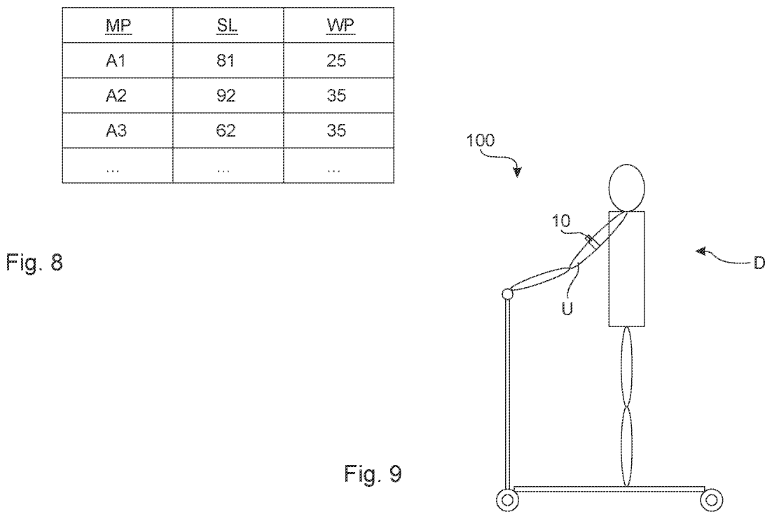

FIG. 8 shows a possible application of weighting parameters, and

FIG. 9 shows a schematic representation of a signalling system.

According to the invention, a signalling device 10 is shown, by way of example, in FIG. 1. Here, the signalling device 10 has an elongated extension from left to right, composing the main extension from the fastening section 20. FIG. 2 shows a corresponding top view from the left side, clearly showing the curved design of the fastening section 20. This curved design of a metal snap band as fastening section 20 allows a snap fastening to be used as a reversible attachment to the upper arm U of the driver D, as shown for example in FIG. 9.

In addition, FIG. 1 shows a rigid housing section which encloses the control module 40. In this control module 40, corresponding switches 42 are provided on the upper and lower sides of the associated housing of the control module 40 which can be pressed simultaneously by means of an index finger and thumb of the driver D. In this way, it is possible to switch the control module 40 on and off. FIG. 1 further shows how a plurality of individual signalling means 32 in the form of LEDs are arranged in matrix form on the surface of the fastening section 20 as signalling element 30. These individual LEDs as signalling means 32 can preferably be controlled individually, so that flashing signals, running signals or continuously illuminated signals can be generated as light signals by a method according to the invention. In particular, these signalling means 32 are multicoloured in design, so that not only a single colour, but also colour differences can be generated as a light signal.

An embodiment of a signalling device 10 according to FIGS. 1 and 2 can be gripped by the driver D in the region of the housing of the control module 40. The pre-tensioning of the fastening section 20 can then be released by a movement on the upper arm U of the driver D. The corresponding movement as snap-on attachment movement now places the fastening section 20 around the upper arm U of the driver D. In the case of thin upper arms U, a part of the fastening section 20, in particular the right-hand end of the fastening section 20, comes to lie on the outer side or the inner side of the control module 40 or the corresponding housing. The individual elements and individual modules, which will be explained later, are arranged within the control module 40.

FIG. 3 shows schematically a cross-section through a signalling device 10. Here again it is easy to see that an elongated extension of the fastening section 20 is provided, in particular in the form of a snap band. On the upper side, a plurality of signalling means 32 are again provided as signalling element 30, which are again preferably designed as LEDs. The entire system of the signalling device 10 is surrounded here by a cover C, at the ends of which a watertight seal inside the cover C can be provided, in particular by welding. This means that the signalling device 10 can be sealed in a watertight manner and can also be used under adverse environmental conditions, for example in the rain. The cover C is preferably tube-like in design in order to facilitate assembly.

In addition, a vibration element 44 is shown in FIG. 3 which can also be controlled by the control module 40. This vibration module 44 is able to generate a vibration signal which can transmit feedback to the driver D by directly contacting the upper arm U on the underside of the signalling device 10 in the attached state. It can be also be seen in FIG. 3 that a sensor element 50 and a distinguishing element 60 are provided inside the control module 40 in order for a method according to the invention to be carried out with the advantages mentioned.

FIG. 4 shows in more detail how a control module 40 can be constructed. In particular, the electrical connections are also shown here, which can for example extend from the control module 40 designed in the form of a board. For example, in this case a metallic or sheet-like embodiment of the fastening section 20 is provided which preferably includes the snap fastening, as has already been explained. A relatively large electrical storage element 70 is integrated here as a battery device to supply the system or the signalling device 10 with power. To charge the electrical storage device 70, contactless charging is possible here. Such contactless charging, for example via inductive charging cycles, is possible here with the charging element which is provided on the underside and thus outside the metallic basic construction of the fastening section 20. If such a signalling device 10 with the charging element 80 is placed on the underside of an inductive charger, the charging process for charging the electrical storage element 70 can start.

FIG. 4 further shows that the control module 40 is preferably designed as a board. Individual elements, for example the sensor element 50 and/or the distinguishing element 60, may be arranged on the upper side of this control module 40 in the form of a board. In particular, the distinguishing element 60 may be integrated into a corresponding computing unit. In addition, a communication module 90 is also provided on the upper side which in this case is able to carry out wireless communication, in particular low-energy wireless communication. For example, it can be a Bluetooth module, in particular a Bluetooth low energy module. The control module 40 is connected on the right, via a signalling coupling, to the signalling element 30 in the form of the signalling means 32 and can preferably control these individually. This makes it possible to generate light signals, continuous light signals, alternating light signals or even differently varying coloured light signals, depending on the design of the individual signalling means 32.

Finally, a vibration element 44 is also provided in the embodiment of FIG. 4 which protrudes through the solid structure of the fastening section 20 and accordingly comes into direct contact with the upper arm U when attached to the upper arm U of the driver D. Only a cover C, which can for example be a flexible cover C, lies between the upper arm U and the vibration element 44 to provide a waterproof seal. The aforementioned vibration signals can be transmitted to a driver D in this way.

FIG. 5 shows schematically how a sensor element 50 in the form of an acceleration sensor can record movement parameters MP in three axes. These movement parameters MP are shown here along the X-axis, the Y-axis and the Z-axis over time. For each of these movement parameters MP, different signalling limit values SL are provided here which preferably all need to be exceeded or fallen below together, i.e. at the same time, in order to lead to the recognition of an intentional gesture. Naturally, these signalling limit values can be fixed but, as has already been explained, can also be variable.

FIG. 6 shows the application of a distinguishing filter DF. For example, it is possible that accelerations or gyro parameters MP registered as movement parameters at particularly high frequencies originate from vibrations of the vehicle or unevenness in the road surface. In order to prevent such driving influences and disturbing factors leading to false recognition of a possibly unintentional gesture, the distinguishing filter DF can for example filter out high frequencies. In FIG. 6, processing of the input signal of the movement parameter MP causes this to change and, after filtering, now no longer exceeds the signalling limit value SL, which remains unchanged. This clearly shows that, with known solutions, in this case a gesture would have been recognised, while by applying a distinguishing filter DF in the present case this false gesture is not recognised and accordingly a light signal is not erroneously generated.

FIG. 7 shows how the positioning parameters PP can be used. Here, the signal of the movement parameter MP remains the same, but a positioning parameter PP, for example resulting from the higher or lower positioning or positioning on the left or right upper arm U of the driver, leads to the signalling limit value SL being reduced. Accordingly, the evaluation or interpretation of the unchanged curve of the movement parameter MP changes. It should also be noted that an adjustment of the signalling limit value SL and also an application of a distinguishing filter DF can of course be combined.

FIG. 8 also shows how different signalling limit values SL or their exceeding or underachievement can also be weighted. Thus, different movement parameters MP, schematically represented by A1, A2 and A3, can have different signalling limit values SL. These different signalling limit values SL are weighted differently here, so that their exceeding or underachievement can be taken into account in different ways in the evaluation and interpretation.

FIG. 9 shows how one or more signalling devices 10 are arranged on the upper arm U of a driver D of a vehicle. In this embodiment, the signalling system 100 is composed of two signalling devices 10 which are in particular of identical design. These different and individual signalling devices 10 are attached, respectively, one to the left and one to the right upper arm U of the driver D.

The above explanation of the embodiments describes the present invention exclusively with reference to examples. Naturally, individual features of the embodiments can, if technically expedient, be freely combined with each other without departing from the scope of the present invention.

### LIST OF REFERENCE SIGNS

10 signalling device
20 fastening section
30 signalling element
32 signalling means
40 control module
42 switch
44 vibration element
50 sensor element
60 distinguishing element
70 electrical storage element
80 charging element
90 communication module
100 signalling system
C cover
D driver
U upper arm
MP movement parameter
PP positioning parameter
WP weighting parameter
SL signalling limit value
DF distinguishing filter

1. Signalling device for generating a light signal when driving a vehicle, comprising a fastening section allowing reversible attachment to an upper arm (U) of a driver (D) of the vehicle and a signalling element with a plurality of signalling means for generating the light signal, further comprising a control module for controlling the signalling element with at least one sensor element for detecting gestures of the upper arm (U) of the driver (D), wherein the control module further comprises a distinguishing element (60) for distinguishing the recognised gestures of the upper arm (U) of the driver (D) from driving movements of the driver (D) when driving the vehicle.

2. Signalling device according to claim 1, wherein the fastening section is designed, at least in sections, as a resilient snap fastening.

3. Signalling device according to claim 1, wherein the control module is arranged at one end of the fastening section.

4. Signalling device according to claim 1, wherein the signalling means are at least partially, in particular completely or substantially completely, arranged on the fastening section.

5. Signalling device according to claim 1, wherein the control module has at least two switches, which are preferably arranged on two opposite sides of the control module.

6. Signalling device according to claim 1, wherein the control module has an electrical storage element and a charging element for contactless charging of the electrical storage element.

7. Signalling device according to claim 1, wherein the control module has a communication module for wireless communication.

8. Signalling device according to claim 1, wherein the control module includes at least one of the following sensor elements:
distance sensor
acceleration sensor
gyro sensor
blind spot sensor
light sensor
magnetic sensor
attachment sensor.

9. Signalling device according to claim 1, wherein the control module has a vibration element for outputting a vibration signal and/or an acoustic element for outputting an acoustic signal to the driver (D).

10. Signalling device according to claim 1, wherein the signalling element has a cover (C), which in particular also surrounds the control module, which is preferably transparent and/or partially transparent.

11. Signalling system comprising at least two signalling devices with the features of claim 1.

12. Recognition method for recognising a gesture of an upper arm (U) of a driver (D) in a signalling device with the features of claim 1, comprising the following steps:
registering movement parameters (MP) of movements of the upper arm (U) by means of the at least one sensor element,
comparing registered movement parameters (MP) with signalling limit values (SL),
generating the light signal based on the result of the comparison.

13. Recognition method according to claim 12, wherein the registered movement parameters (MP) are filtered by means of a distinguishing filter (DF), the filtered version then being used as a basis for comparison.

14. Recognition method according to claim 12, wherein at the beginning of the method at least one positioning parameter (PP) is registered which is in particular specific for at least one of the following positionings:
positioning on the left or right upper arm (U) of the driver (D)
positioning with respect to gravity
positioning in relation to the vehicle.

15. Recognition method according to claim 14, wherein, on the basis of the at least one positioning parameter (PP) registered, at least one signalling limit value (SL) and/or a distinguishing filter (DF) and/or a weighting parameter (WP) for at least one axis of the movement parameter (MP) is changed.

16. Recognition method according to claim 12, wherein at least one signalling limit value (SL) and/or a distinguishing filter (DF) and/or a weighting parameter (WP) is adjusted by means of an input step.

17. Recognition method according to claim 12, wherein when activating and/or deactivating the control module a specific light signal is output via the signalling element, in particular including information about an electrical charge state.

18. Recognition method according to claim 12, wherein the type and/or direction of the generated light signal is dependent on a detected and/or specified positioning of the signalling device.

19. Recognition method according to claim 12, wherein in an application to a signalling system the signalling device and at least one additional signalling device, the control modules of the signalling devices communicate with each other and in particular coordinate the generated light signals and/or check the registered movement parameters (MP) for plausibility.

20. Recognition method according to claim 12, wherein a switch-off movement and/or a switch-on movement is detected on the basis of the movement parameters (MP) and the control module is then switched off and/or switched on.
